(19) United States
(12) Patent Application Publication
(10) Pub. No.: US 2011/0182142 A1
(43) Pub. Date: Jul. 28, 2011

(54) Technique and Apparatus for Seismic Data Quality Control

(76) Inventors: Qinglin Liu, Oslo (NO); Kambiz Iranpour, Oslo (NO)

(21) Appl. No.: 12/694,375

(22) Filed: Jan. 27, 2010

(51) Int. Cl. G01V 1/28

(52) U.S. Cl. 367/47

(57) ABSTRACT

A technique includes receiving seismic data acquired in a seismic survey and performing quality control analysis on a given trace indicated by the seismic data. The quality control analysis includes selectively accepting or rejecting the given trace based on a median trend of other trace amplitudes determined from traces associated with sensor positions near a sensor position associated with the given trace.

### BACKGROUND

The invention generally relates to a technique and apparatus for seismic data quality control.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones) and others are sensitive to particle motion (e.g., geophones). Industrial surveys may deploy only one type of sensors or both. In response to the detected seismic events, the sensors generate electrical signals to produce seismic data. Analysis of the seismic data can then indicate the presence or absence of probable locations of hydrocarbon deposits.

One type of seismic source is an impulsive energy source, such as dynamite for land surveys or a marine air gun for marine surveys. The impulsive energy source produces a relatively large amount of energy that is injected into the earth in a relatively short period of time. Accordingly, the resulting data generally has a relatively high signal-to-noise ratio, which facilitates subsequent data processing operations. The use of an impulsive energy source for land surveys may pose certain safety and environmental concerns.

Another type of seismic source is a seismic vibrator, which is used in connection with a “vibroseis” survey. For a seismic survey that is conducted on dry land, the seismic vibrator imparts a seismic source signal into the earth, which has a relatively lower energy level than the signal that is generated by an impulsive energy source. However, the energy that is produced by the seismic vibrator's signal lasts for a relatively longer period of time.

### SUMMARY

In an embodiment of the invention, a technique includes receiving seismic data acquired in a seismic survey in which energy from multiple seismic sources overlap in at least one of time and space. The technique includes performing quality control analysis on a given trace indicated by the seismic data, including selectively accepting or rejecting the given trace based on a median trend of other trace amplitudes determined from other traces associated with sensor positions near a sensor position associated with the given trace.

Advantages and other features of the invention will become apparent from the following drawing, description and claims.

### BRIEF DESCRIPTION OF THE DRAWING

FIG. 1 a schematic diagram of a vibroseis acquisition system according to an embodiment of the invention.

FIGS. 2 and 3 are flow diagrams depicting seismic data quality control techniques according to embodiments of the invention.

FIG. 4 is an illustration of a simulated slip-sweep record using two-dimensional shots according to an embodiment of the invention.

FIG. 5 is a plot of root mean square amplitude versus trace number illustrating seismic data quality control analysis according to an embodiment of the invention.

FIG. 6 is a schematic diagram of a processing system according to an embodiment of the invention.

### DETAILED DESCRIPTION

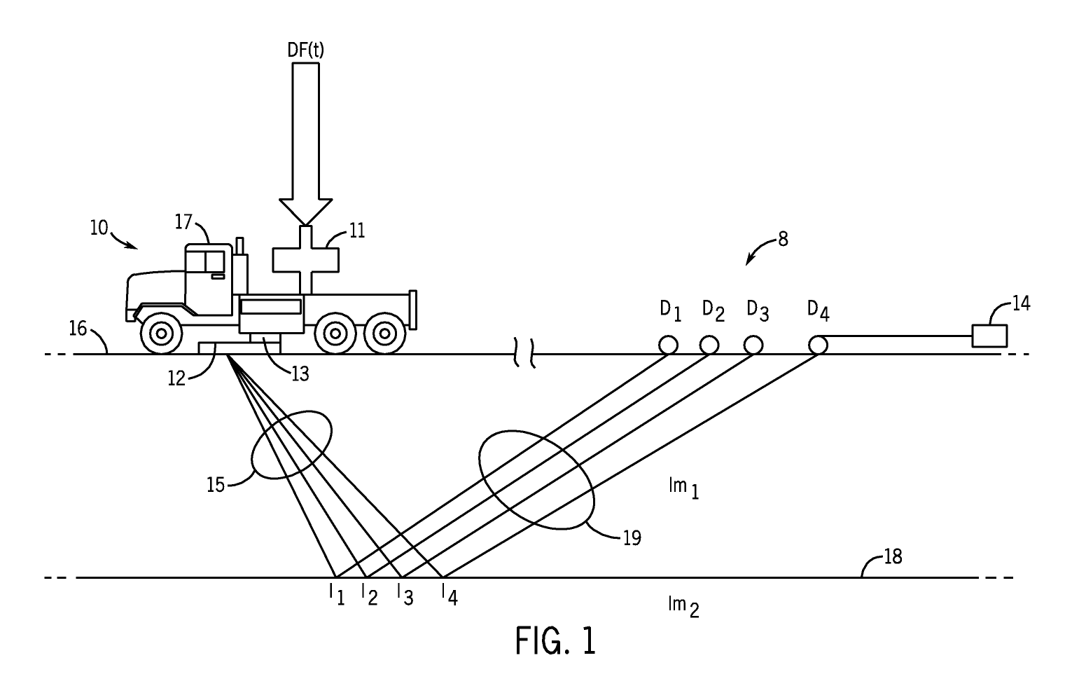

Referring to FIG. 1, an exemplary land-based vibroseis acquisition system 8 in accordance with embodiments of the invention includes multiples seismic vibrators 10 (one of which is depicted in FIG. 1); surface-located geophones D₁, D₂, D₃ and D₄; and a data acquisition system 14. As part of operations associated with a vibroseis survey, the seismic vibrator 10 generates at least one vibroseis seismic sweep. More specifically, FIG. 1 depicts a subsurface sweep signal 15 that is generated by the vibrator 10 during the survey for purposes of injecting a vibroseis sweep into the earth. An interface 18 between subsurface impedances Im₁ and Im₂ reflects the signal 15 at points I₁, I₂, I₃ and I₄ to produce a reflected signal 19 that is detected by the geophones D₁, D₂, D₃ and D₄, respectively. The geophones D₁, D₂, D₃ and D₄ acquire measurements of sweeps that are generated by other seismic vibrators 10, as described further below. The data acquisition system 14 gathers the raw seismic data acquired by the geophones D₁, D₂, D₃ and D₄, and the raw seismic data may be processed to yield information about subsurface reflectors and the physical properties of subsurface formations.

For purposes of generating the signal 15, the seismic vibrator 10 may contain an actuator (a hydraulic or electromagnetic actuator, as examples) that drives a vibrating element 11 in response to a sweep pilot signal (called “DF(t)” in FIG. 1). More specifically, the DF(t) signal may be a sinusoid whose amplitude and frequency are changed during the generation of the sweep. Because the vibrating element 11 is coupled to a base plate 12 that is in contact with the earth surface 16, the energy from the element 11 is coupled to the earth to produce the signal 15.

Among its other features, the seismic vibrator 10 may include a signal measuring apparatus 13, which includes sensors (accelerometers, for example) to measure the signal 15 (i.e., to measure the output ground force of the seismic vibrator 10). As depicted in FIG. 1, the seismic vibrator 10 may be mounted on a truck 17, an arrangement that enhances the vibrator's mobility.

The vibrating element 11 contains a reaction mass that oscillates at a frequency and amplitude that is controlled by the DF(t) pilot signal: the frequency of the DF(t) signal sets the frequency of oscillation of the reaction mass; and the amplitude of the oscillation, in general, is controlled by a magnitude of the DF(t) signal. During the generation of the sweep, the frequency of the DF(t) signal transitions (and thus, the oscillation frequency of the reaction mass transitions) over a range of frequencies, one frequency at time. The amplitude of the DF(t) signal may be linearly or non-linearly varied during the generation of the sweep pursuant to a designed amplitude-time envelope.

It is noted that unlike the seismic vibrator 10, a seismic vibrator may alternatively be constructed to be located in a borehole, in accordance with other embodiments of the invention. Thus, seismic sensors, such as geophones, may alternatively be disposed in a borehole to record measurements produced by energy that is injected by borehole-disposed vibrators. Although specific examples of surface-located seismic vibrators and seismic sensors are described herein, it is understood that the seismic sensors and/or the seismic vibrators may be located downhole in accordance with other embodiments of the invention.

Due to the mechanics and movement of the seismic vibrator, the overall time consumed in generating a vibroseis sweep significantly exceeds the sweep length, or duration, which is just one component of the overall time. For example, the overall time involved in generating a particular vibroseis sweep includes a time associated with deploying the base plate (such as the base plate 12 depicted in FIG. 1); the time to raise the base plate; and a time to move the seismic vibrator from the previous location to the location in which the sweep is to be injected. Therefore, for purposes of increasing acquisition efficiency, a vibroseis seismic acquisition system may include multiple seismic vibrators that generate multiple vibroseis sweeps in a more time efficient manner, as compared to generating the sweeps with a single seismic vibrator. Care is exercised to ensure that the multiple seismic vibrators are operated in a manner that permits separation of the corresponding sensed seismic signals according to the sweep that produced the signal (i.e., for purposes of source separation). One technique involves using multiple seismic vibrators to generate a succession of vibroseis sweeps and imposes a “listening time” interval between successive sweeps (i.e., an interval between the end of a particular sweep and the beginning of the next consecutive sweep). With this approach, the measurements produced by a given sweep are recorded during the listening time before the next sweep begins.

For purposes of further increasing the acquisition efficiency when multiple seismic vibrators are used, a “slip sweep” technique may be used. In the slip sweep technique, a particular sweep begins without waiting for the previous sweep to terminate. In the absence of harmonic noise, if the time interval between the beginning, or firing, of consecutive sweep sequences (called the “slip time”) is greater than the listening time, then the seismic responses to the consecutive sweep sequences do not overlap in the time-frequency domain, which facilitates separation of the measurements.

Conventionally, quality control is performed on the seismic data for purposes of filtering weak or noisy traces from the other data. Quality control has conventionally been performed by determining a root mean-square (RMS) amplitude of a given trace over a certain window of time. A polynomial is fitted into a plot of the RMS amplitude versus offset. This plot may be, for example, a logarithm of the RMS amplitude versus a logarithm of the offset. The fitted polynomial is used to identify weak or noisy traces in that thresholds may employed above and below the filled polynomial to identify the undesirable traces. In order for this type of quality of control to be adequate, one source is assumed for each shot.

However, for advanced source techniques, such as the above-described slip sweep technique, one source for each shot cannot be assumed. The slip sweep technique is one of many advanced source techniques, such as independent simultaneous source (ISS), distant separated simultaneous source (DSSS), where data is recorded in a continuous mode and each record may contain several shots where data may be overlapped either in time (slip-sweep), in space (ISS or DSSS) or in both time and space (ISS). Therefore, the conventional seismic data quality control techniques, such as the one set forth above, which are based on a single source assumption, do not adequately sort out the weak or noisy traces from the other traces.

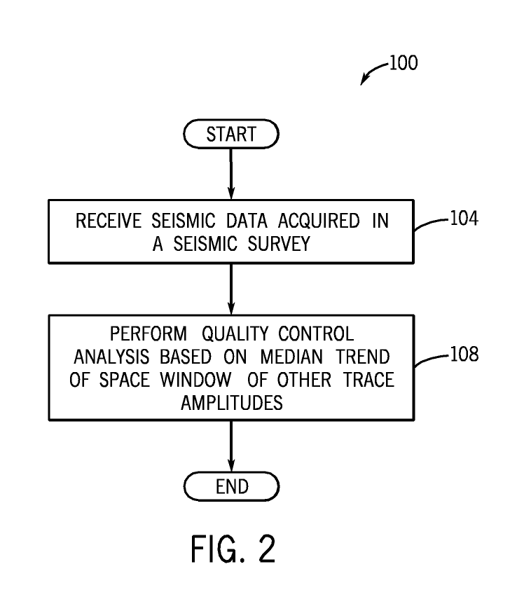

In accordance with embodiments of the invention described herein, a technique 100, which is depicted in FIG. 2, may be used for quality control where the seismic data overlaps in time and/or space. Pursuant to the technique 100, seismic data are received (block 104), which have been acquired in a seismic survey. The seismic survey may be a survey that employs an advanced high productivity source technique, such as slip-sweep, ISS, DSSS and other surveys, which have data that overlap in time, in space, or both time and space. Pursuant to the technique 100, a quality control analysis is performed (block 108) on the traces indicated by the seismic data based on a median trend of the trace amplitudes. By evaluating the traces relative to the median trend, each trace's RMS amplitude may be compared with thresholds relative to the median trend to determine whether the trace is noisy or weak and thus, to determine whether or not the trace should be accepted or rejected.

Among the advantages of the technique 100, the technique 100 is relatively simple and easy to implement for field applications, requires no data sorting and saves computational time. Other and/or different advantages are contemplated in accordance with other embodiments of the invention.

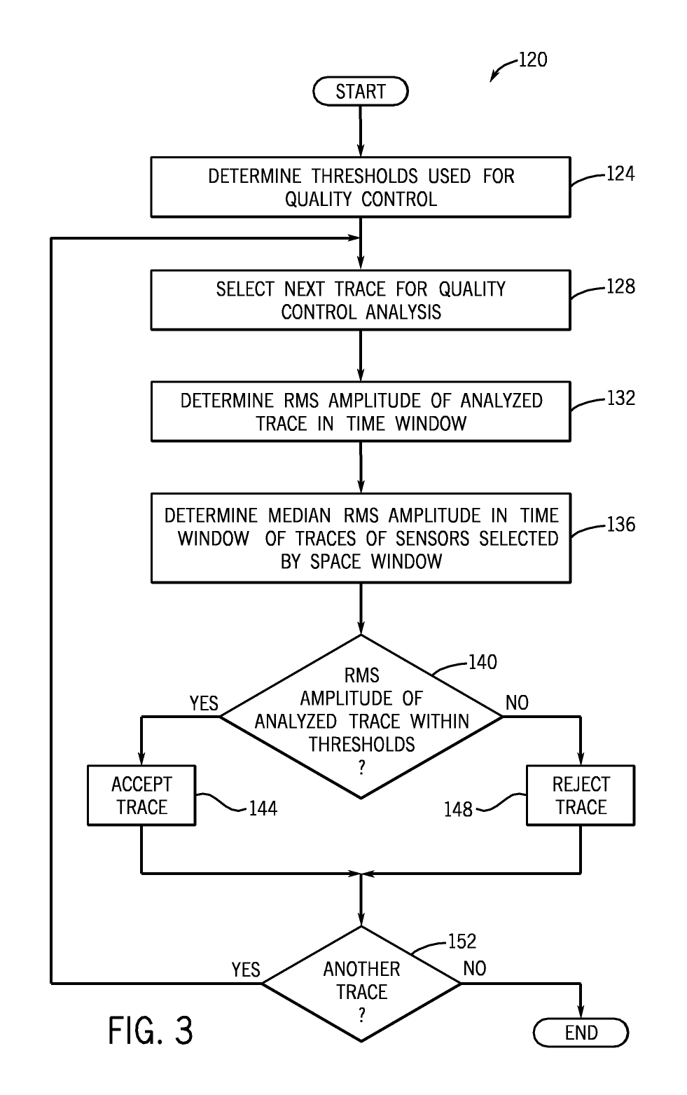

Referring to FIG. 3, as a more specific example, a technique 120 may be used for purposes of evaluating traces for purposes of performing seismic data quality control. Pursuant to the technique 120, thresholds are determined relative to the derived median trend, pursuant to block 124. As non-limiting examples, the thresholds may be absolute thresholds relative to the median trend, percentage thresholds above and below the median trend or some other relationship to establish upper and lower boundaries for the comparison.

The analysis of a particular trace begins in block 128 in which the next trace is selected for analysis. The technique 120 includes determining (block 132) the RMS amplitude for the trace being analyzed in a given time window. The technique 120 further includes determining the median RMS amplitudes in the same time window for traces of nearby sensors. In this regard, in accordance with some embodiments of the invention, the technique 120 determines the median trend by establishing a “sliding” space window to select RMS amplitudes for a range of offsets near the offset position of the trace being analyzed such that all RMS amplitudes identifies by the sliding window are averaged to derive the median trend value for the offset position of the analyzed trace. The sliding space window may cover a predetermined number of offsets before and a predetermined number of offsets after the offset of the trace being analyzed.

Thus, in accordance with some embodiments of the invention, the RMS amplitude is determined for each of the traces identified by the space window. A median of the RMS amplitudes is then determined for all of the RMS amplitudes within the space window. From the median value, the upper and lower thresholds may then be determined and used for comparison with the RMS amplitude of the trace amplitude under analysis to determine (diamond 140) whether the amplitude is within the thresholds. If so, the trace is accepted, pursuant to block 144. Otherwise, the trace is rejected, pursuant to block 148.

The technique 120 proceeds through the other traces in a similar manner by moving the space window in space and performing the analysis on the next trace. In this regard, if the technique 120 determines (diamond 152) that another trace remains for processing, then control returns to block 128.

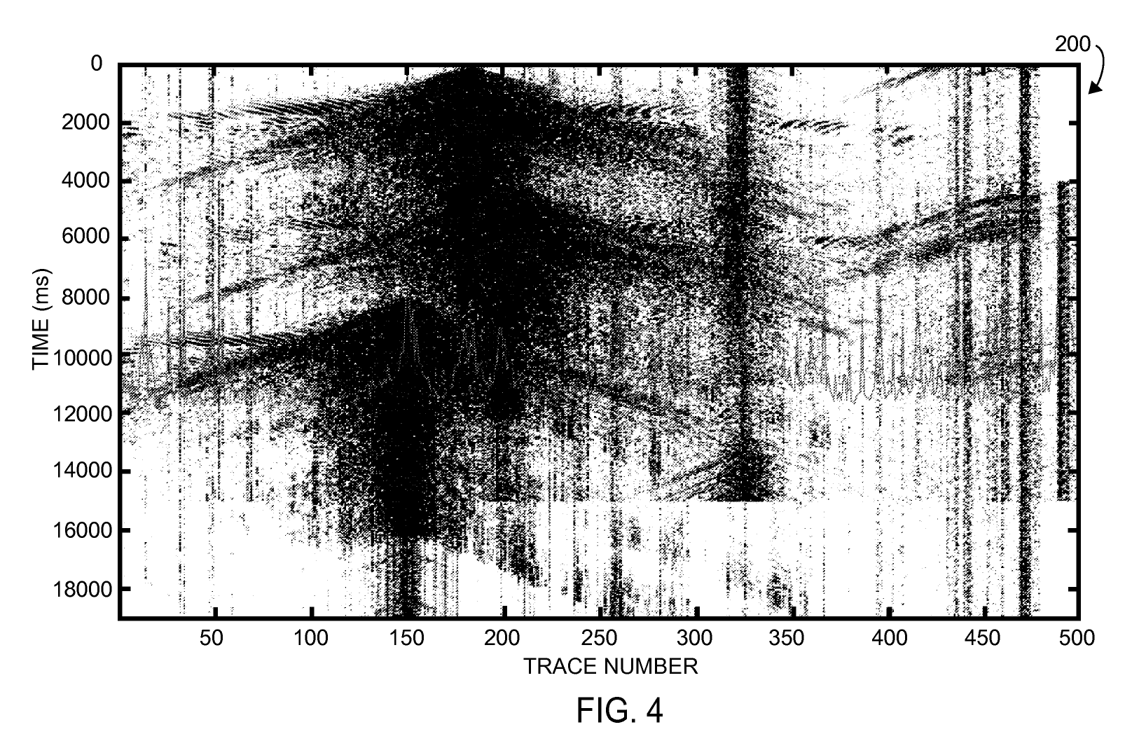

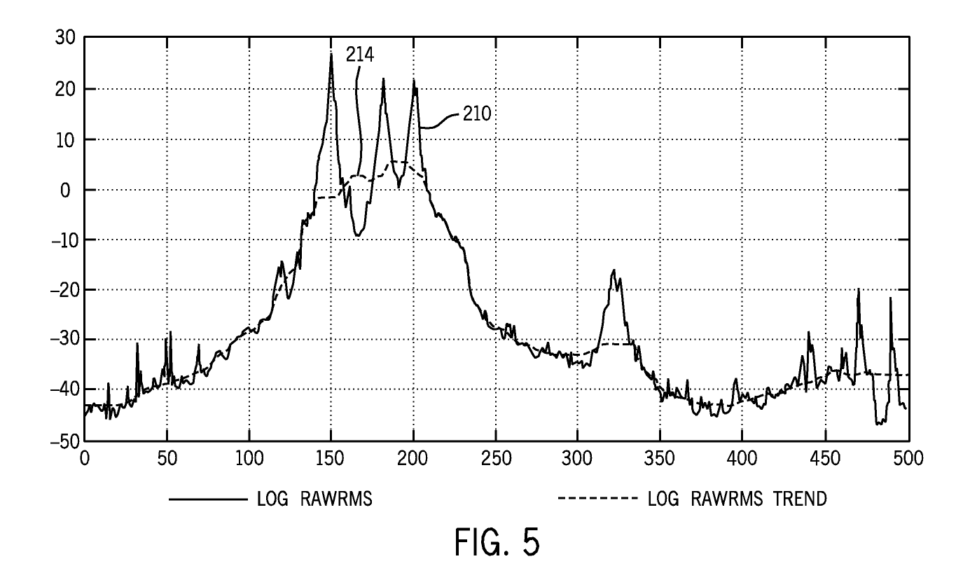

As a non-limiting example, FIG. 4 depicts a slip-sweep record 200, which was simulated with two-dimensional shot gathers. From the record 200, a logarithmic plot 210 of the RMS amplitude versus trace number is plotted in FIG. 5. It is noted that due to the relatively quick amplitude variation of seismic data near seismic sources, a misfit may happen around the source. However, these problems may be avoided by masking traces within a given offset (such as 100 m, for example) near the source. Also depicted in FIG. 5 is a logarithmic plot 214 of the median trend versus trace number. By comparing the amplitude 210 to the median trend 214, weak and noisy traces may be identified.

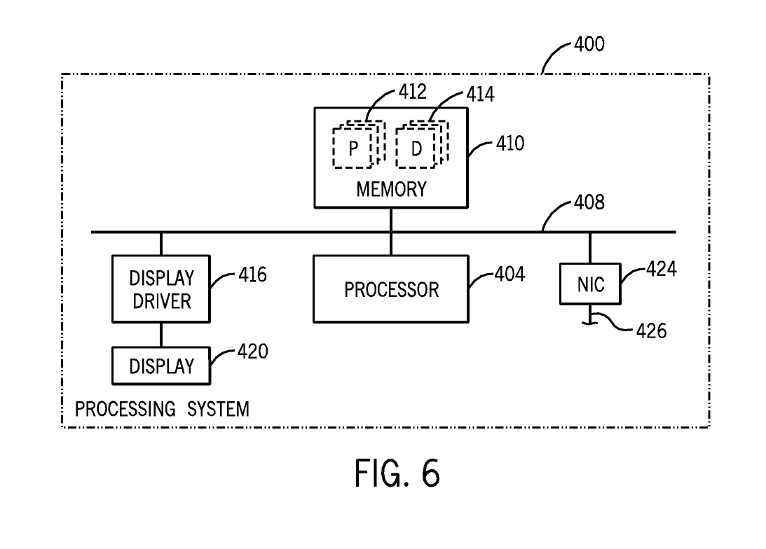

Referring to FIG. 6, in accordance with some embodiments of the invention, a processing system 400 may be used for purposes of performing the seismic data quality control analysis that is disclosed herein. It is noted that the architecture of the processing system 400 is illustrated merely as an example, as the skilled artisan would recognize many variations and deviations therefrom.

In the example that is depicted in FIG. 6, the processing system 400 includes a processor 404, which executes program instructions 412 that are stored in a system memory 410 for purposes of causing the processor 404 to perform some or all of the techniques that are disclosed herein. As non-limiting examples, the processor 404 may include one or more microprocessors and/or microcontrollers, depending on the particular implementation. In general, the processor 404 may execute program instructions 412 for purposes of causing the processor 404 to perform all or parts of the techniques 100 and/or 120, in accordance with some embodiments of the invention.

The memory 410 may also store datasets 414 which may be initial, intermediate and/or final datasets produced by the processing by the processor 404. For example, the datasets 414 may include data indicative of seismic data, RMS amplitudes, the median trend, the median of RMS amplitudes in the sliding spatial window, upper and lower trace amplitude rejection thresholds, identity of accepted or rejected traces, etc.

As depicted in FIG. 6, the processor 404 and memory 410 may be coupled together by at least one bus 408, which may couple other components of the processing system 400 together, such as a network interface card (NIC) 424. As a non-limiting example, the NIC 424 may be coupled to a network 426, for purposes of receiving such data as seismic data acquired in a high efficiency, multiple source survey. As also depicted in FIG. 6, a display 420 of the processing system 408 may display initial, intermediate or final results produced by the processing system 400. In general, the display 420 may be coupled to the system 400 by a display driver 416. As a non-limiting example, the display 420 may display an image, which graphically depicts RMS amplitude versus sensor offset graphs, median trends, time versus trace number records, etc.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
receiving seismic data acquired in a seismic survey in which energy from multiple seismic sources overlap in at least one of time and space; and
performing quality control analysis on a given trace indicated by the seismic data, comprising selectively accepting or rejecting the given trace based on a median trend of other amplitudes determined from other traces associated with sensor positions near a sensor position associated with the given trace.

2. The method of claim 1, wherein the act of performing quality control analysis comprises:
applying an offset window to identify the other traces;
determining a first amplitude of the given trace;
determining the amplitudes of the other traces;
determining the median trend based at least in part on the determined amplitudes of the other traces; and
selectively accepting or rejecting the given trace based on a comparison of the first amplitude with the median trend.

3. The method of claim 2, wherein the act of determining the first amplitude comprises determining a root mean square amplitude over a predetermined window of time.

4. The method of claim 2, wherein the act of determining the amplitudes of the other traces comprises determining a root mean square amplitude over a predetermined window of time.

5. The method of claim 1, wherein the act of performing quality control analysis comprises:
establishing at least one threshold relative to the median trend;
comparing an amplitude of the given trace to said at least one threshold; and
selectively accepting or rejecting the given trace based on the comparison.

6. The method of claim 1, further comprising:
selectively performing the quality control analysis based on proximity of the given trace to a seismic source.

7. The method of claim 1, wherein the seismic survey comprises a survey in which energy from multiple sources overlaps in time and/or space.

8. The method of claim 1, wherein the seismic survey comprises one of the following:
an independent simultaneous source survey, a slip sweep survey and a distant separated simultaneous source survey.

9. A system comprising:
an interface to receive seismic data acquired in a seismic survey in which energy from multiple seismic sources overlap in at least one of time and space; and
a processor to perform quality control analysis on a given trace indicated by the seismic data, the processor adapted to selectively accept or reject the given trace based on a median trend of other amplitudes determined from other traces associated with sensor positions near a sensor position associated with the given trace.

10. The system of claim 9, wherein the processor is adapted to:
apply an offset window to identify the other traces;
determine a first amplitude of the given trace;
determine the amplitudes of the other traces;
determine the median trend based at least in part on the determined amplitudes of the other traces; and
selectively accept or reject the given trace based on a comparison of the first amplitude with the median trend.

11. The system of claim 10, wherein the processor is adapted to:
determine a root mean square amplitude over a predetermined window of time to determine the first amplitude of the given trace.

12. The system of claim 10, wherein the processor is adapted to:
determine a root mean square amplitude over a predetermined window of time to determine the amplitudes of the other traces.

13. The system of claim 9, wherein the processor is adapted to:
establish at least one threshold relative to the median trend;
compare an amplitude of the given trace to said at least one threshold; and
selectively accept or reject the given trace based on the comparison.

14. The system of claim 9, wherein the processor is adapted to selectively perform the quality control analysis based on proximity of the given trace to a seismic source.

15. The system of claim 9, wherein the seismic survey comprises a survey in which energy from multiple sources overlaps in time and/or space.

16. The system of claim 9, wherein the seismic survey comprises one of the following:
an independent simultaneous source survey, a slip sweep survey and a distant separated simultaneous source survey.

17. An article comprising a computer readable storage medium storing instructions that when executed by a computer cause the computer to:
receive seismic data acquired in a seismic survey in which energy from multiple seismic sources overlap in at least one of time and space; and
perform quality control analysis on a given trace indicated by the seismic data by selectively accepting or rejecting the given trace based on a median trend of other amplitudes determined from other traces associated with sensor positions near a sensor position associated with the given trace.

18. The article of claim 17, the storage medium storing instructions that when executed by the computer cause the computer to:
apply an offset window to identify the other traces;
determine a first amplitude of the given trace;
determine the amplitudes of the other traces;
determine the median trend based at least in part on the determined amplitudes of the other traces; and
selectively accept or reject the given trace based on a comparison of the first amplitude with the median trend.

19. The article of claim 18, the storage medium storing instructions that when executed by the computer cause the computer to:
determine a root mean square amplitude over a predetermined window of time to determine the first amplitude of the given trace.

20. The article of claim 18, the storage medium storing instructions that when executed by the computer cause the computer to:
determine a root mean square amplitude over a predetermined window of time to determine the amplitudes of the other traces.

21. The article of claim 17, the storage medium storing instructions that when executed by the computer cause the computer to:
establish at least one threshold relative to the median trend;
compare an amplitude of the given trace to said at least one threshold; and
selectively accept or reject the given trace based on the comparison.

22. The article of claim 17, the storage medium storing instructions that when executed by the computer cause the computer to:
selectively perform the quality control analysis based on proximity of the given trace to a seismic source.

23. The article of claim 17, wherein the seismic survey comprises a survey in which energy from multiple sources overlaps in time and/or space.

24. The article of claim 17, wherein the seismic survey comprises one of the following:
an independent simultaneous source survey, a slip sweep survey and a distant separated simultaneous source survey.
